(19) United States
(12) Patent Application Publication
(10) Pub. No.: US 2011/0064630 A1
(43) Pub. Date: Mar. 17, 2011

(54) MULTI-WELL IMPROVED PLATE

(75) Inventors: Jeffrey Leonard Coulling, Kent (GB); Simon May, Surrey (GB)

(73) Assignee: ADVANCED BIOTECHNOLOGIES LIMITED, Surrey (GB)

(21) Appl. No.: 12/299,202

(22) PCT Filed: Feb. 4, 2008
(86) PCT No.: PCT/GB08/00352

§ 371 Date: Jan. 26, 2010

(30) Foreign Application Priority Data
Feb. 2, 2007 (GB) 0701999.5

(51) Int. Cl. B01L 3/00

(52) U.S. Cl. 422/552

(57) ABSTRACT

A thin walled multi-well plate for PCR use comprising: (i) a deck and skirt portion said deck and skirt portion having an outer surface and an inner surface; (ii) a plurality of wells for holding chemical reactants, each well comprising a well wall having an inner surface and an outer surface; wherein the deck and skirt portion and the plurality of wells are of integral construction and formed from the same plastics material, and wherein the deck and skirt portion has a mean thickness from 1.5 mm±10% to 3 mm±10%.

### FIELD OF THE INVENTION

The present invention relates to multi-well plates or titre plates used as containers for chemical or biological reactions, such as polymerase chain reactions (PCR) or for storage of chemical or biochemical samples, and to methods of manufacturing such plates. It is particularly applicable, but in no way limited, to rigid plastic PCR plates and to methods for their manufacture.

### BACKGROUND OF THE INVENTION

Multi-well plates, or two-dimensionally bound arrays of wells or reaction chambers, are commonly employed in research and clinical procedures for the screening and evaluation of multiple samples. Multi-well plates are especially useful in conjunction with automated thermal cyclers for performing the widely used polymerase chain reaction or “PCR”, and for DNA cycle sequencing and the like. They are also highly useful for biological micro-culturing and assay procedures, and for performing chemical synthesis on a micro scale.

Multi-well plates may have wells or tubes that have single openings at their top ends, similar to conventional test tubes and centrifuge tubes, or they may incorporate second openings at their bottom ends which are fitted with frits or filter media to provide a filtration capability. As implied above, multi-well plates are most often used for relatively small-scale laboratory procedures and are therefore also commonly known as “microplates”. Example multi-well plates are disclosed in EP 0638364, GB 2288233, U.S. Pat. No. 3,907,505 and U.S. Pat. No. 4,968,625.

Multi-well plates for PCR use are typically comprised of a plurality of plastic tubes arranged in rectangular planar arrays of typically 3×8 (a 24 well plate), 6×8 (a 48 well plate) or 8×12 (a 96 well plate) tubes with an industry standard 9 mm (0.35 in.) centre-to centre tube spacing (or fractions thereof). As technology has advanced plates with a larger number of wells have been developed such as 16×24 (a 384 well plate).

In PCR multi-well plates, the bottoms of the tubes are generally of a rounded conical shape. They may alternatively be flat-bottomed (as typical with either round or square-shaped designs used with optical readers).

A horizontally disposed tray or plate portion generally extends integrally between each tube, interconnecting each tube with its neighbour in a cross-web fashion. The perimeter of the plate portion is commonly formed with a skirt extending downwardly beneath the plate portion. The skirt is integrally formed with the plate portion during moulding of the plate and generally forms a continuous wall of constant height around the plate. This skirt thus both lends stability to the plate when it is placed on a surface and some rigidity when the plate is being handled.

Research techniques that use multi-well plates include, but are not limited to, quantitative binding assays, such as radioimmuniassay (RIA) or enzyme-linked immunosorbant assay (ELISA), combinatorial chemistry, cell-based assays, thermal cycle DNA sequencing and polymerase chain reaction (PCR), both of which amplify a specific DNA sequence using a series of thermal cycles. Each of these techniques makes specific demands on the physical and material properties and surface characteristics of the sample wells. For instance, RIA and ELISA require surfaces with high protein binding; combinatorial chemistry requires great chemical and thermal resistance; cell-based assays require surfaces compatible with sterilization and cell attachment, as well as good transparency for certain applications; and thermal cycling requires low protein and DNA binding, good thermal conductivity, and moderate thermal resistance.

Compatibility of these plates with automated equipment has become increasingly important, since many laboratories automate the filling, and emptying of the wells, which often contain five microlitres or less, as well as their handling. Accordingly, it is desirable to use a multi-well plates that is conducive to use with robotic equipment and which can withstand robotic gripping and manipulation.

In the case of multi-well plates intended for PCR use there is a further important requirement, which is that the well walls should be as thin as possible. Such thin-well microplates are designed to accommodate the stringent requirements of thermal cycling and are designed to improve thermal transfer to the samples contained within the sample wells. The sample wells are typically conical shaped to allow the wells to nest into corresponding conical shaped heating/cooling blocks in the thermal cyclers. The nesting feature of sample wells helps to increase surface area of the thin-well microplates while in contact with the heating/cooling blocks and thus helps to facilitate heating and cooling of samples.

It will therefore be appreciated that thin-well microplates require a specific combination of physical and material properties for optimal robotic manipulation, liquid handling, and thermal cycling. These properties consist of rigidity, strength and straightness required for robotic plate manipulation; flatness of sample well arrays required for accurate and reliable liquid sample handling; physical and dimensional stability and integrity during and following exposure to temperatures approaching 100° C.; and thin-walled sample wells required for optimal thermal transfer to samples. These various properties tend to be contradictory. For instance polymers offering improved rigidity and/or stability typically do not possess the material properties required to be biologically compatible and/or to form thin-walled sample tubes.

Typically PCR plates are manufactured by one-piece polymer injection moulding because of the cost-effectiveness of this process. Various structural features are incorporated into the microplates in order to improve the strength, rigidity and flatness of the end product. For example, ribs may be incorporated into the underside of the multi-well plates to reinforce flatness and rigidity. However, such structural features are limited in their size and shape by the requirement that such plates must fit into thermal cyclers. A further option to enhance rigidity and flatness of multi-well plates includes using polymers that naturally impart rigidity and flatness to the plates. However, the selected polymer must also meet the physical and material property requirements of thin-well microplates in order for the plates to function correctly during thermal cycling.

In practice, most PCR plates in use today are manufactured from a polyolefine, typically polypropylene, in a one-shot injection moulding process. Polypropylene is used because the flow properties of molten polypropylene allow consistent moulding of a sample well with a wall that is sufficiently thin to promote optimal heat transfer when the sample well array is mounted on a thermal cycler block. In addition, polypropylene does not soften or melt when exposed to the high temperatures of thermal cycling. However, thin-well microplates constructed in this way from polypropylene or polyethylene possess inherent internal stresses which are to be found in moulded parts with complex features and which exhibit thick and thin cross sectional portions throughout the body of the plate. These internal stresses result from differences in cooling rates of the thick and thin portions of the plate body after the moulding process is complete. Furthermore, and equally if not more problematic, further distortions such as warping and shrinkage due to the release of these internal stresses can result when thin-well microplates are exposed to the conditions of the thermal cycling process. The resultant dimensional variations in both flatness and the footprint size can lead to unreliable sample loading and sample recovery when using automated equipment.

To ensure multi-well plates consistently adhere to specifications for rigidity and flatness, manufacturers of prior art multi-well plates employ certain design options, namely incorporating structural features with multi-well plates and using suitable and economical polymers to construct multi-well plates. European Patent EP-B-0106662 discloses a single piece multi-well plate formed from a material having a suppressed or reduced native fluorescence.

A first option of incorporating structural features with multi-well plates includes incorporating ribs with the undersides of multi-well plates to reinforce flatness and rigidity. However, such structural features cannot be incorporated with thin-well microplates used in thermal cycling procedures. Such structural features would not allow samples wells to nest in wells of thermal cycler blocks and, therefore, would prevent effective coupling with block wells resulting in less effective thermal transfer to samples contained within sample wells.

The second option to enhance rigidity and flatness of multi-well plates includes using suitable, economical polymers that impart rigidity and flatness to the plates. Simultaneously the selected polymer must also meet the physical and material property requirements of thin-well microplate sample wells in order for such sample wells to correctly function during thermal cycling. Many prior art multi-well plates are constructed of polystyrene or polycarbonate. Polystyrene and polycarbonate resins exhibit mould-flow properties that are unsuitable for forming the thin walls of sample wells that are required of thin-well microplates. Moulded polystyrene softens or melts when exposed to temperatures routinely used for thermal cycling procedures. Therefore, such polymer resins are not suitable for construction of thin-well microplates for thermal cycling procedures.

Various other attempts have been made in the prior art to overcome these problems. One such example is described in EP1198293 and US 2002/0151045 (M J Research Inc.) which describes a thin-well microplate formed from a skirt and frame portion which accommodates a separate well and deck portion, which may be joined to form the unitary plate. This form of construction is significantly more expensive to manufacture. Cost is a key factor since a high throughput laboratory may use tens of thousands of these thin-well microplates per week.

Another such example is described in EP1161994 and US2005/0058578 (Eppendorf AG) which describes a thin-well microplate formed by 2-shot injection moulding. The skirt, frame and deck portions are integrally moulded from a stiff plastics material. The thin walled wells are then formed by moulding a second plastics material directly to holes in the deck portion. This design is significantly more expensive to manufacture compared to standard plates since two moulds and moulding steps are required. This method of manufacture also leaves open the possibility that one or more wells may become detached from the deck during use.

UK2,288,233 (Akzo Nobel N.V.) describes a type of microtitre plate where an array of microtitre wells sit within a grid of square holes, each hole being adapted to accommodate a well. The grid of holes form an integrated part of a skirted frame portion. Such an arrangement would be impractical for PCR plates since the assembled unit would not and could not function within a thermal cycler.

It will therefore be appreciated that in several of the designs described above, the internal stresses present in a conventional thin-well plate are still present and an additional component has been employed in the hope of controlling these stresses during the thermal cycling process. Thus, in both prior art examples the inherent problem has not been resolved but is still present and an additional plastics or metal component has been added in an attempt to counteract the effect of the inevitable internal stresses. And inevitably the prior art designs cost more to manufacture than a conventional multi-well plate.

It is an object of the present invention to overcome, or to at least mitigate, some or all of the problems described above.

### SUMMARY OF THE INVENTION

According to a first aspect of the invention there is provided a multi-well plate comprising:—
(i) a deck and skirt portion said deck and skirt portion having an outer surface and an inner surface;
(ii) a plurality of wells for holding chemical reactants, each well comprising a well wall having an inner surface and an outer surface;
   wherein the deck and skirt portion and the plurality of wells are of integral construction and formed from the same plastics material, and wherein the deck and skirt portion has a mean thickness from 1.5 mm±10% to 3 mm±10%. This is particularly advantageous as it allows for a single shot injection moulding process to form a rigid multi-well plate wherein the whole of the plate is formed from the same plastics material. The increased thickness of the deck and skirt portion imparts substantial rigidity into the plate without having to resort to the complex two shot injection process and/or after moulding assembly using different plastics materials provided for in the prior art, and without impacting on the well thickness.

Preferably the deck and skirt portion has a mean thickness from 1.7 mm±10% to 2.5 mm±10%.

Preferably the deck and skirt portion has a mean thickness of 1.9 mm±10%.

Preferably the ratio of the thickness of the deck and skirt portion, being the mean value of the internal distance between the outer surface and the inner surface, and the mean value of the thickness of the well wall is 6 or greater.

Preferably the ratio of mean deck and skirt portion thickness to mean well wall thickness is 12 or greater.

Preferably the ratio of mean deck and skirt portion thickness to mean well wall thickness is 20 or greater.

Preferably the ratio of mean deck and skirt portion thickness to mean well wall thickness is 30 or greater.

Preferably the ratio of mean deck and skirt portion thickness to mean well wall thickness is 40 or greater.

Preferably the well wall has a mean thickness from about 0.05 to 0.25 mm.

According to a second aspect of the invention there is provided a multi-well plate comprising:—
(i) a deck and skirt portion said deck and skirt portion having an outer surface and an inner surface;
(ii) a plurality of wells for holding chemical reactants, each well comprising a well wall having an inner surface and an outer surface;
   wherein the deck and skirt portion and the plurality of wells are of integral construction and formed from the same plastics material, and the ratio of the thickness of the deck and skirt portion, being the mean value of the internal distance between the outer surface and the inner surface, and the mean value of the thickness of the well wall is 6 or greater.

Preferably the ratio of mean deck and skirt portion thickness to mean well wall thickness is 12 or greater.

More preferably the ratio of mean deck and skirt portion thickness to mean well wall thickness is 20 or greater.

In a further preferred embodiment the ratio of mean deck and skirt portion thickness to mean well wall thickness is 30 or greater.

In a still further preferred embodiment the ratio of mean deck and skirt portion thickness to mean well wall thickness is 40 or greater.

Preferably the well wall has a mean thickness from about 0.05 to 0.25 mm.

Preferably the deck and skirt portion has a mean thickness from about 1.5 to 3 mm.

### BRIEF DESCRIPTION OF THE DRAWINGS

The present invention will now be described, by way of example, in relation to the accompanying drawings wherein:—

FIGS. 1 to 5 show top elevation, side cross-section, end elevation, well cross-section and stacked views respectively of a prior art 96 well PCR plate;

FIGS. 6,7, 8 and 9 show top elevation, side cross-section, end elevation, and well cross-section views respectively, including dimensions, of a PCR plate according to an embodiment of the present invention;

FIGS. 10, 11, 12 and 13 show top elevation, side cross-section, end elevation and well cross-section views respectively, without dimensions, of a PCR plate according to an embodiment of the present invention;

FIGS. 14 to 20 show top elevation, side cross-section, side elevation, front cross-section, well cross-section, stacked and bottom elevation views respectively, including dimensions, of a PCR plate according to an embodiment of the present invention;

FIGS. 21 to 27 show top elevation, side cross-section, side elevation, front cross-section, well cross-section, stacked and bottom elevation views respectively, including dimensions, of a PCR plate according to an embodiment of the present invention;

FIGS. 28 to 37 show top elevation, side cross-section, side elevation, front cross-section, front elevation, well cross-section in middle of plate, well cross-section on edge of plate with skirt portion, skirt and wall portion cross-section, cross-sectional stacked and bottom elevation views respectively, including dimensions, of a PCR plate according to an embodiment of the present invention.

### DETAILED DESCRIPTION OF THE INVENTION

Preferred embodiments of the present invention will now be more particularly described, by way of example only. These represent the best ways known to the Applicant of putting the invention into practice but they are not the only ways in which this can be achieved.

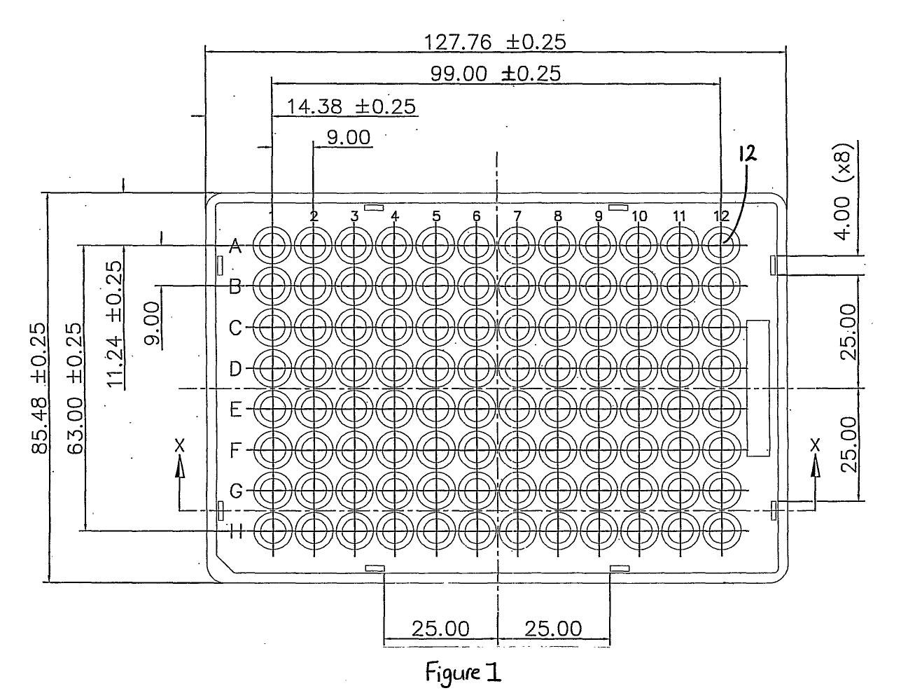

FIGS. 1 to 5 illustrate a prior art 96 well plate together with typical dimensions. These plates 10 comprise a deck portion 11 which supports a plurality of wells 12 in a regular array or matrix. The deck portion serves to connect the adjacent wells near to or at the top of each well and hold them in the desired matrix. Each well has a small chimney 16 around its upper rim, the chimney standing proud of the level of the deck. These chimneys or rims provide for improved sealing of the wells.

Attached to and integral with the deck 11 is a skirt portion 13. this extends down from the perimeter of the deck and the bottom of the skirt 14 is substantially level with the bottom of the well 15. The skirt then provides a degree of rigidity and also enables the plates to be stacked one on top of each other as shown in FIG. 5.

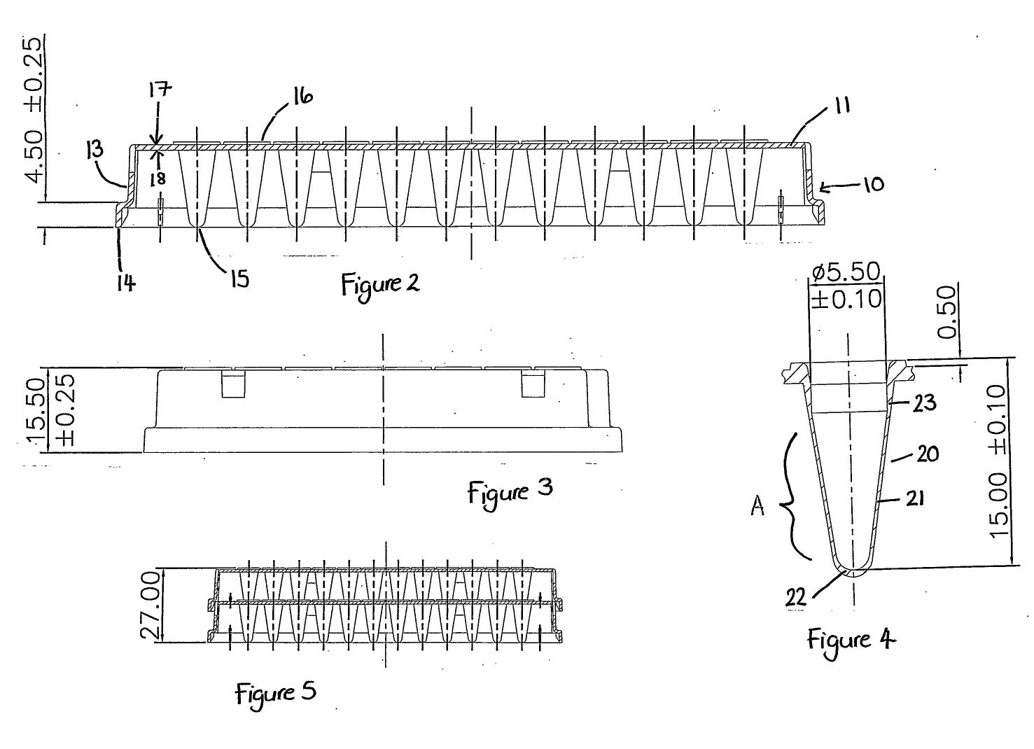

It follows from the above description that the deck and skirt portion has an outer surface and an inner surface, generally shown as 17 and 18 respectively in FIG. 2, and there is a thickness of plastic between these surfaces. Typically the thickness of plastic between these surfaces is between about 0.5 mm and about 0.8 mm up to a maximum of about 1.0 mm in the prior art 96 well plates. It should be appreciated that these values are not intended to represent precise limits, but rather give an indication of the range of thicknesses used in the deck and skirt portions.

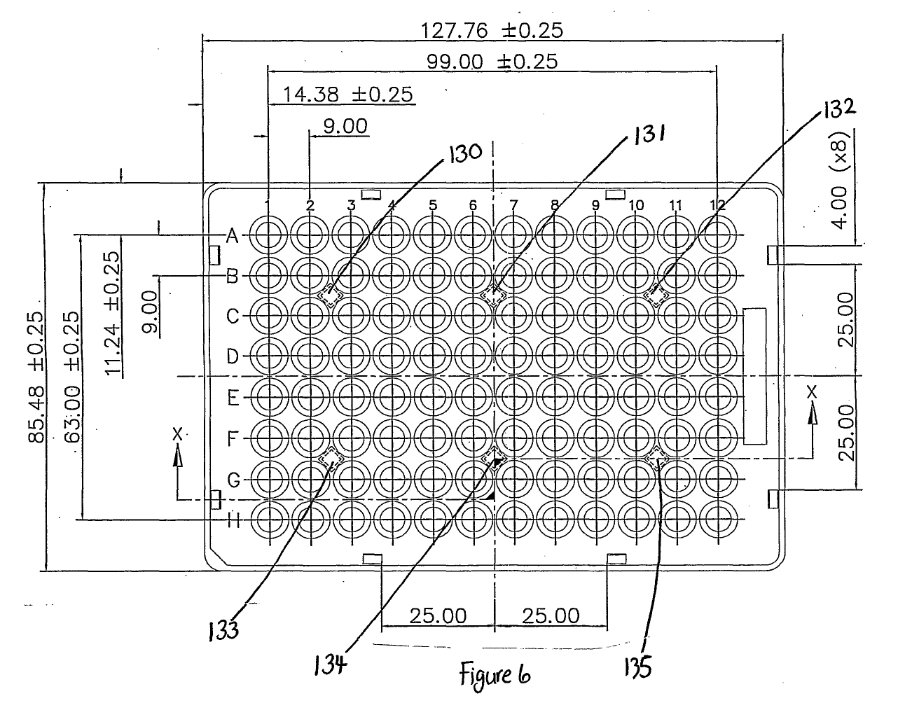

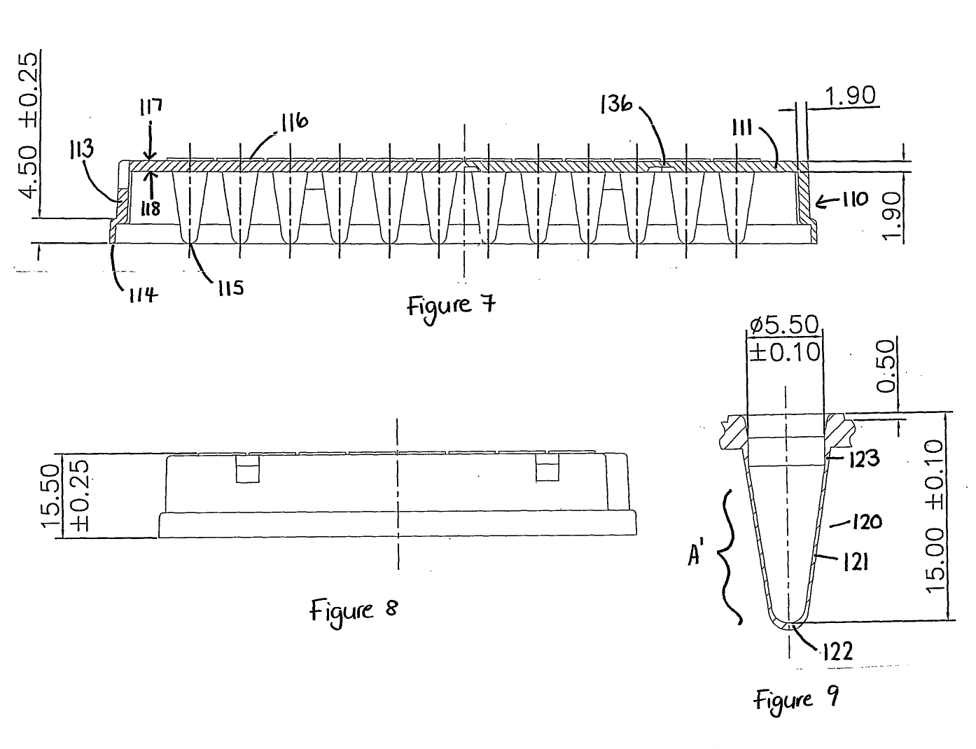

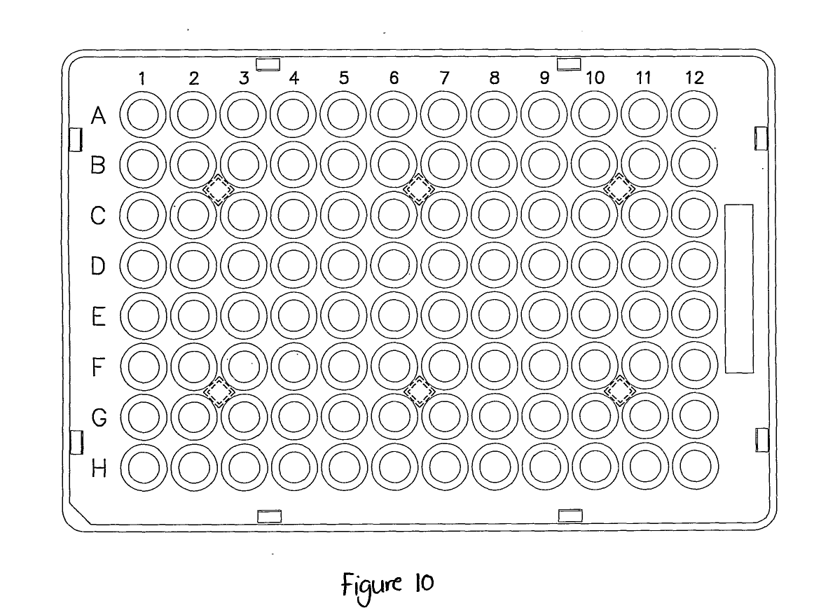

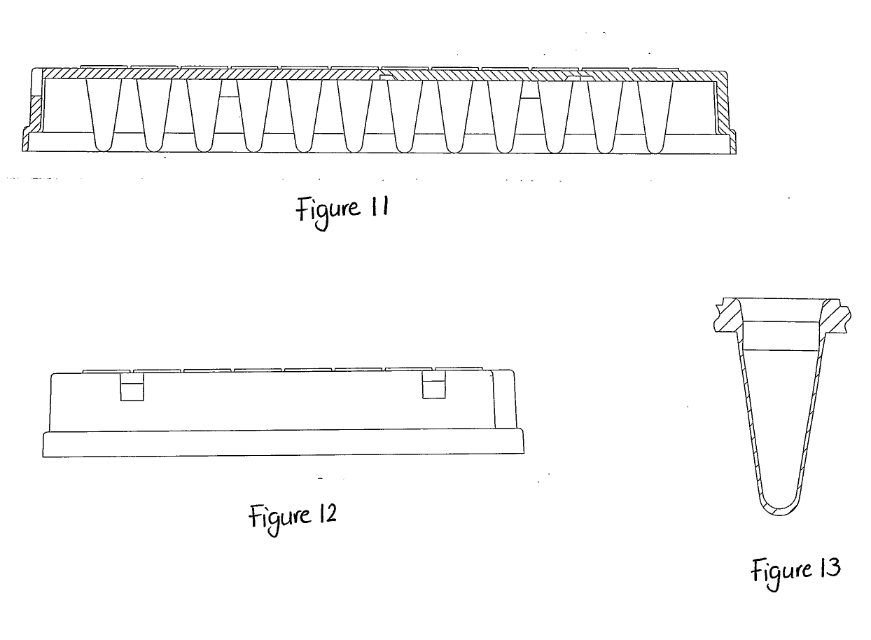

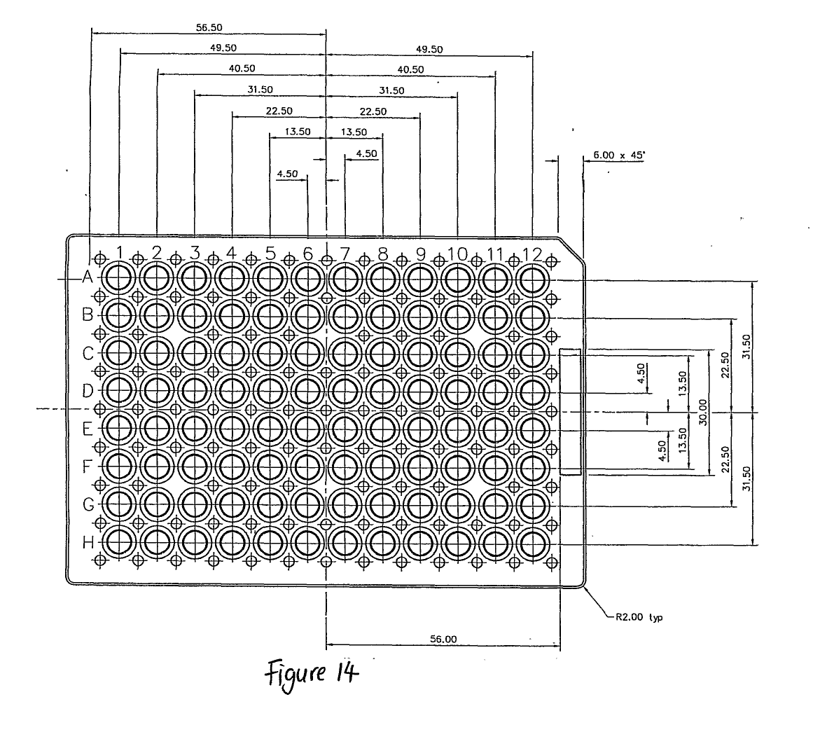

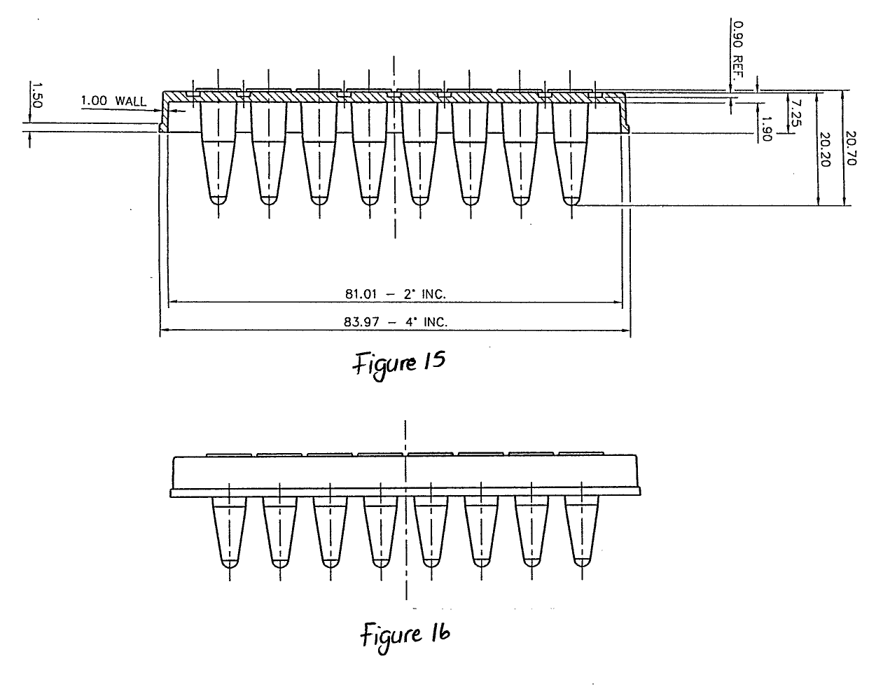

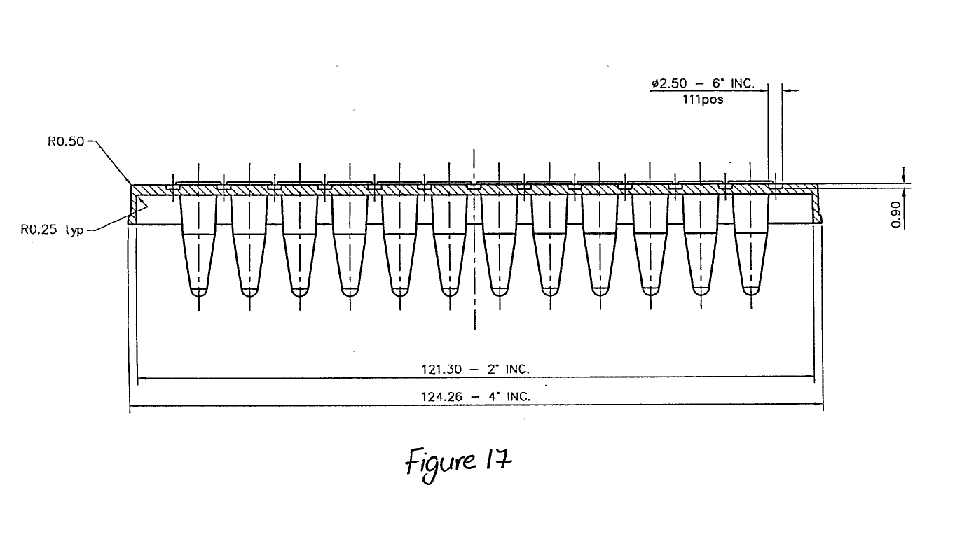

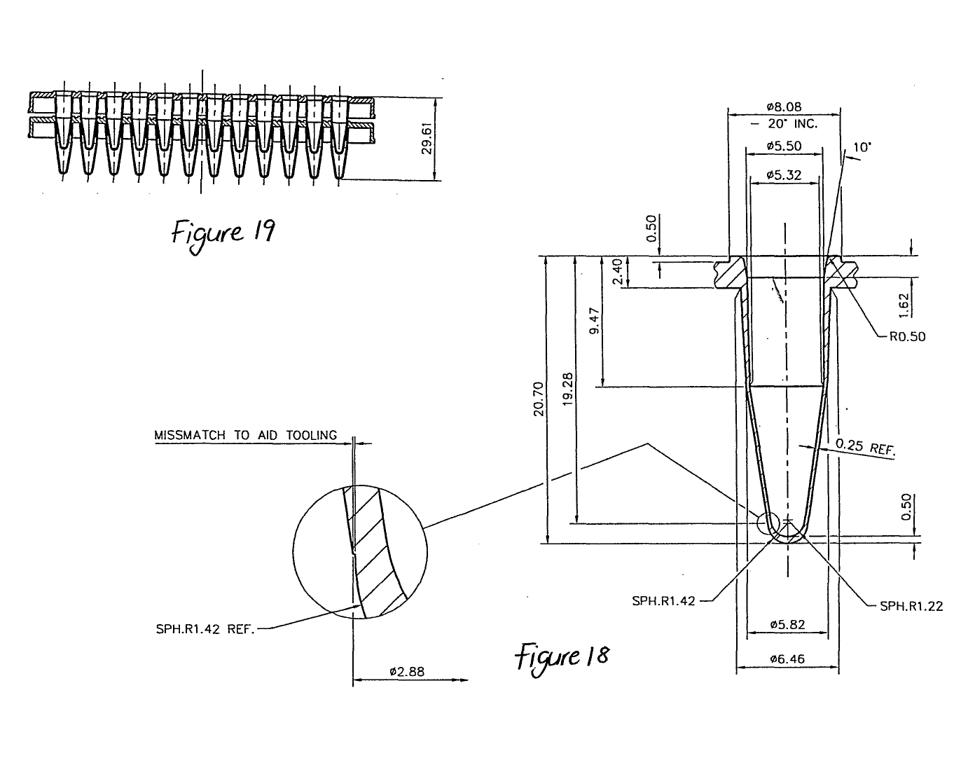

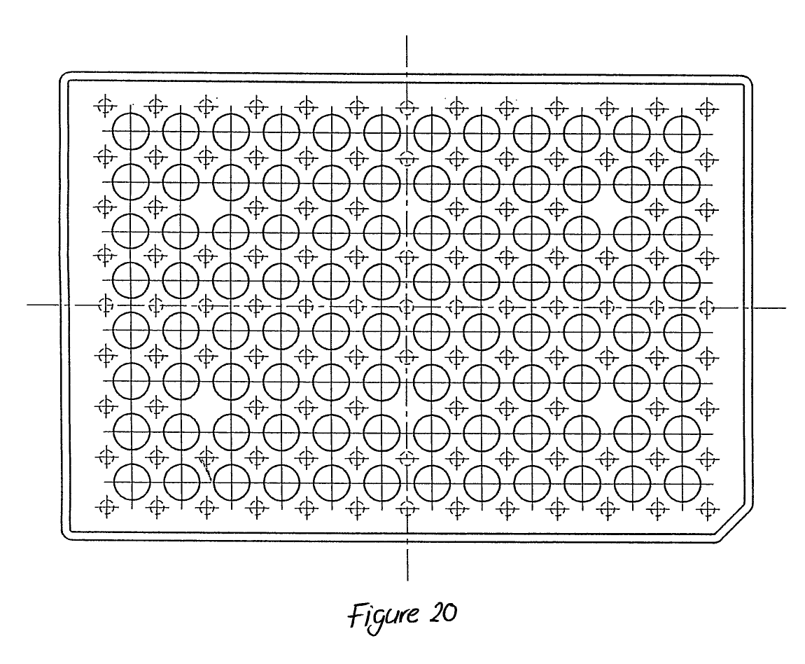

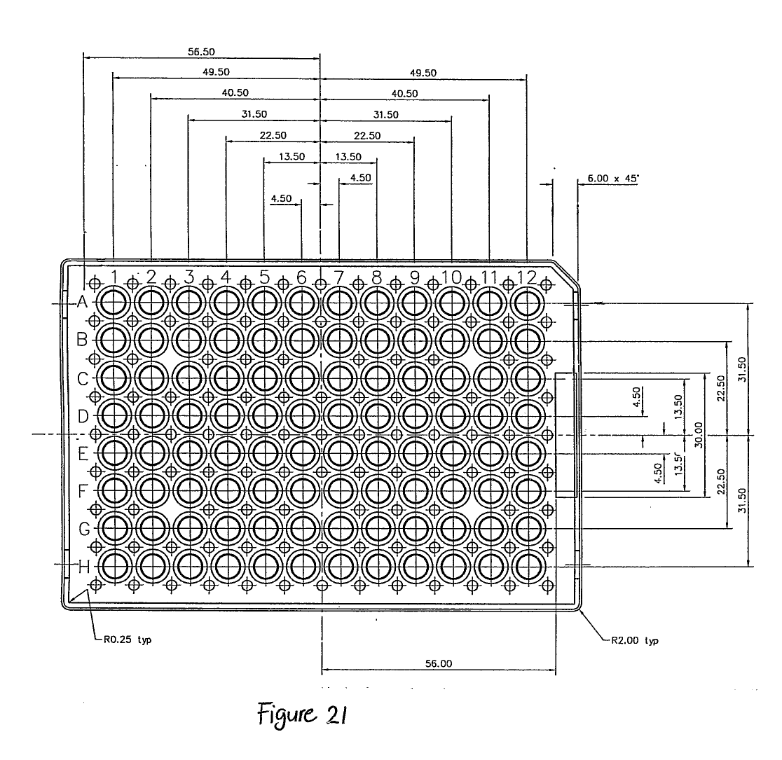

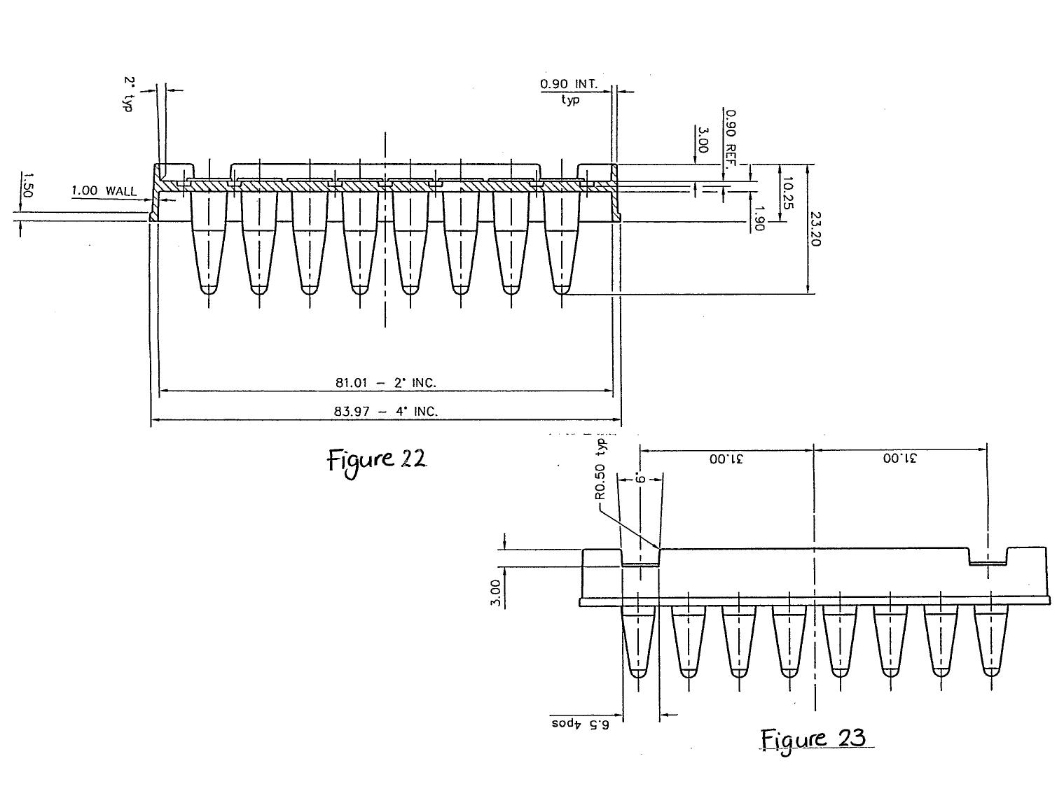

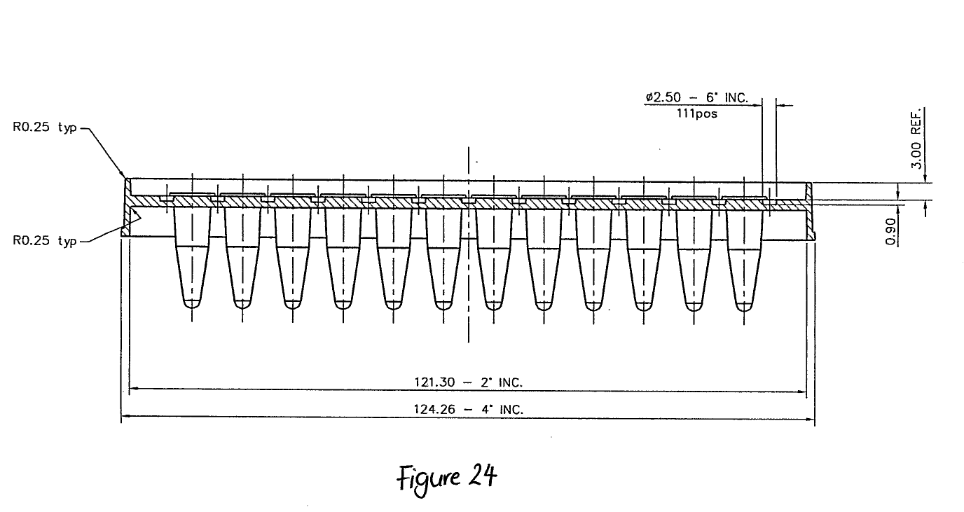

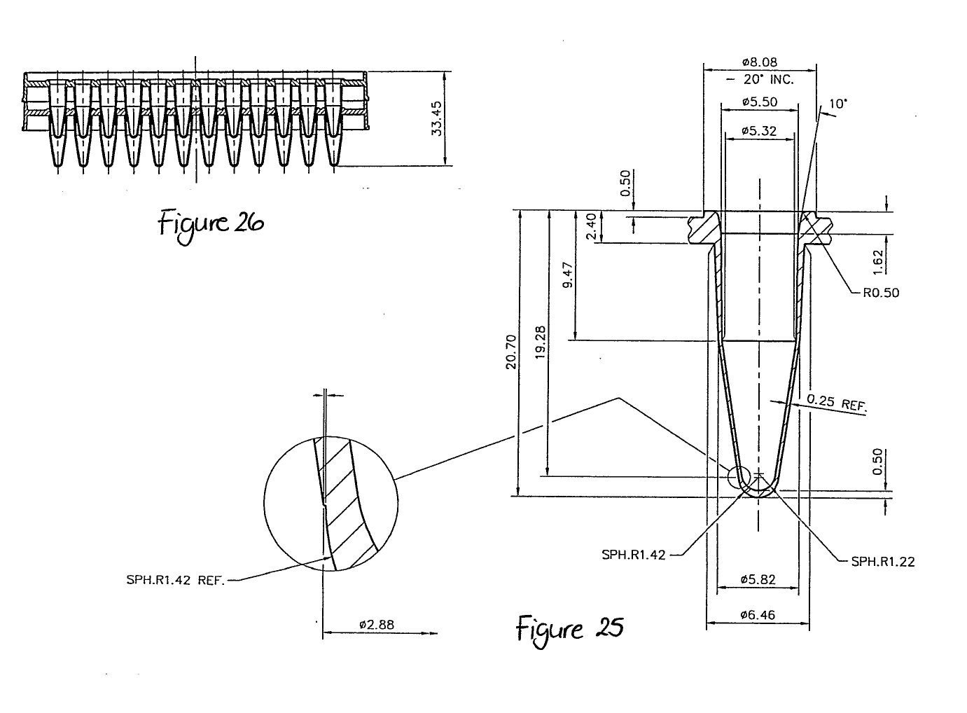

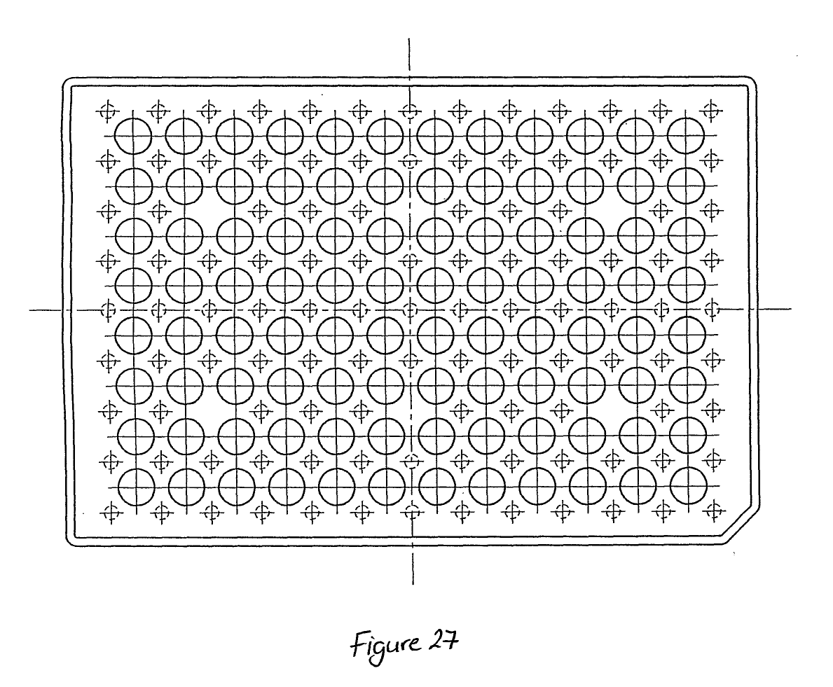

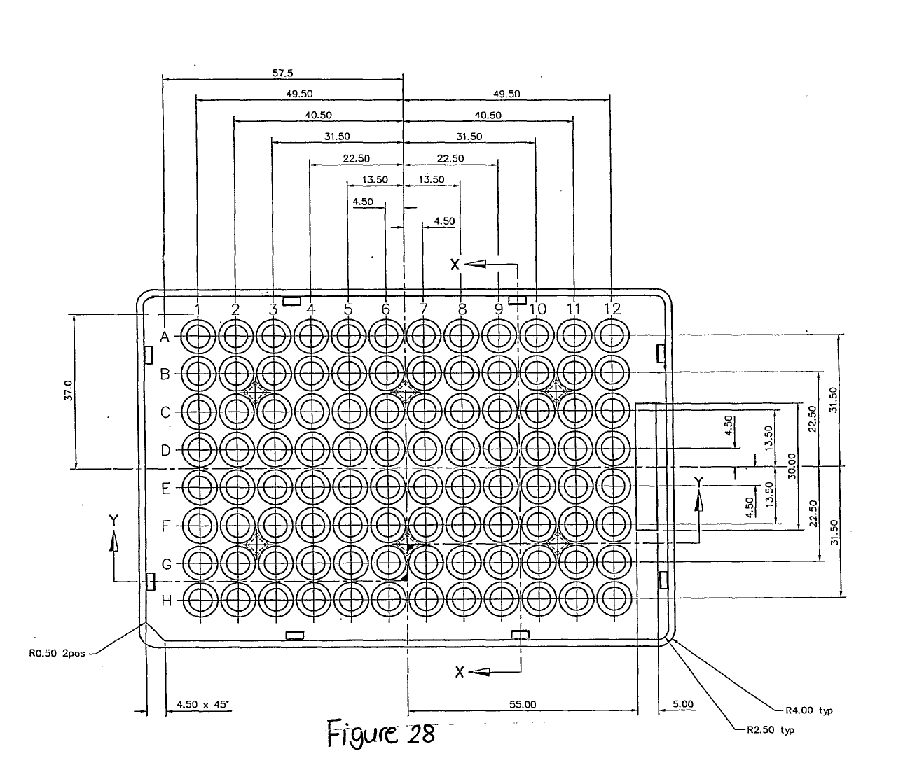

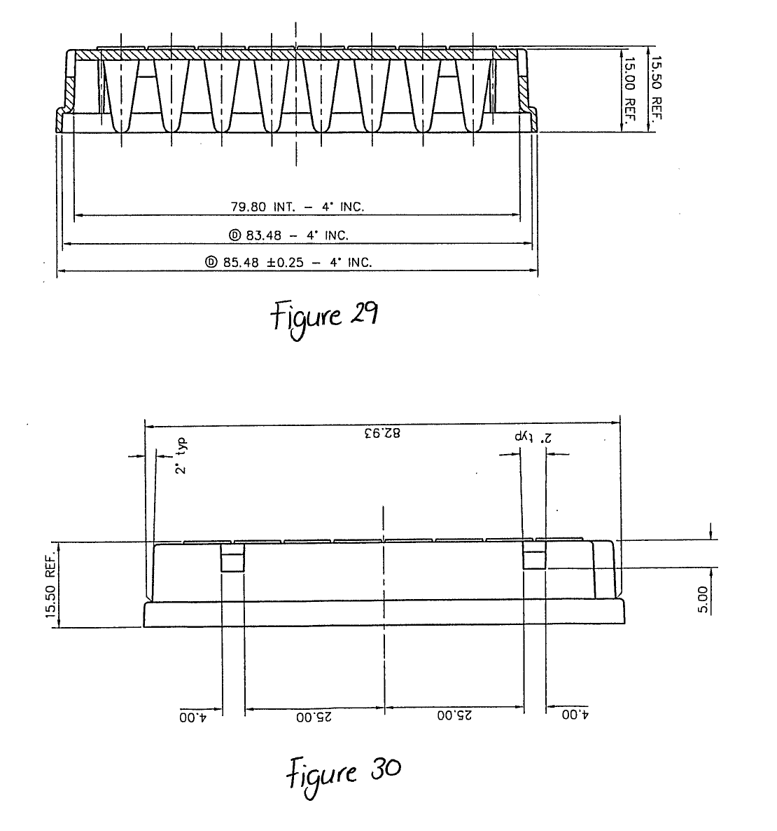

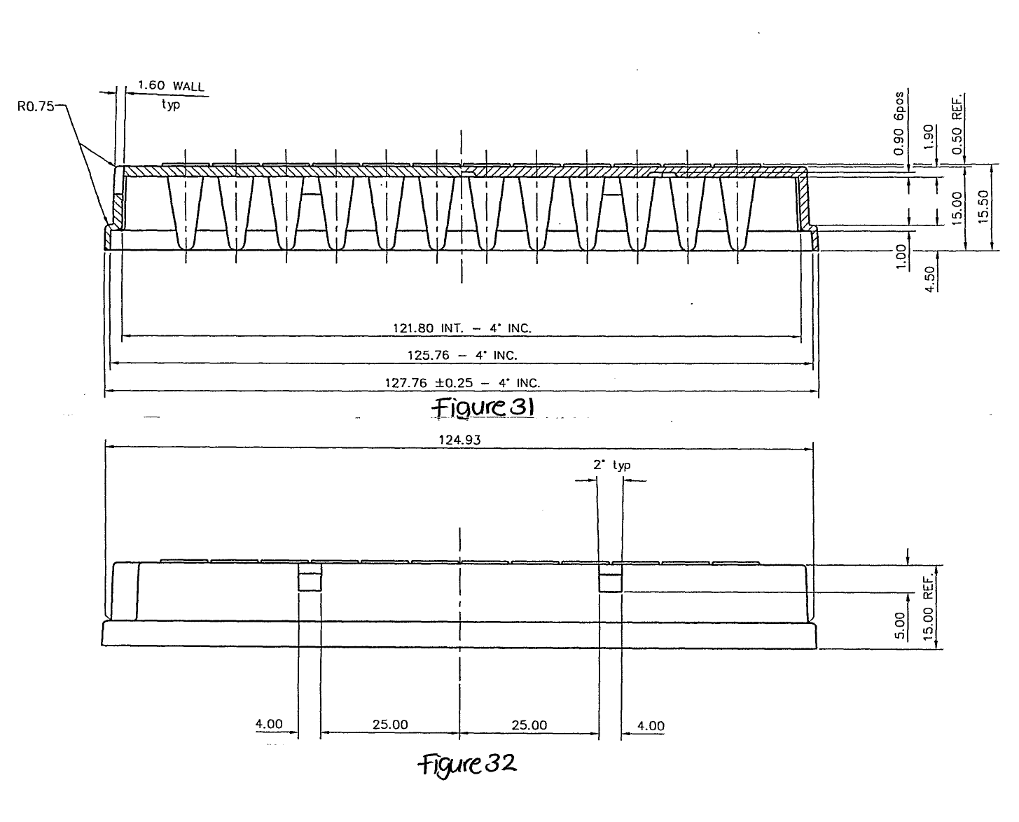

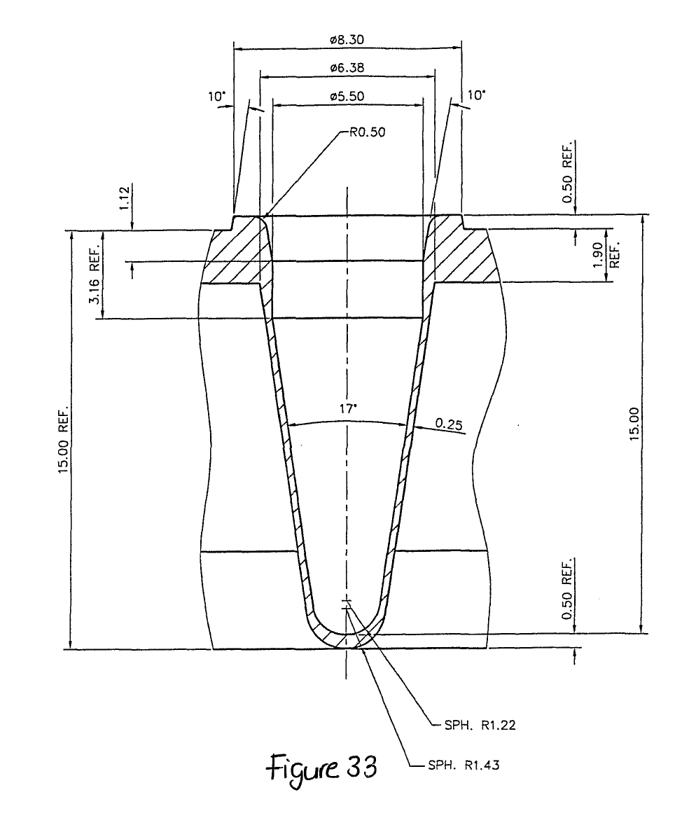

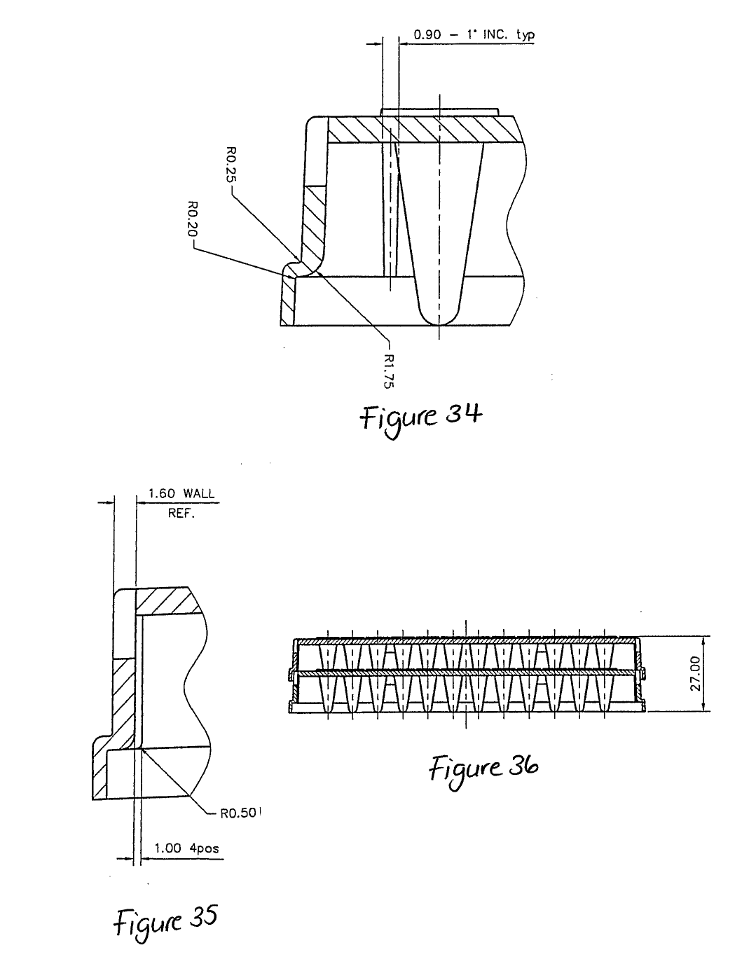

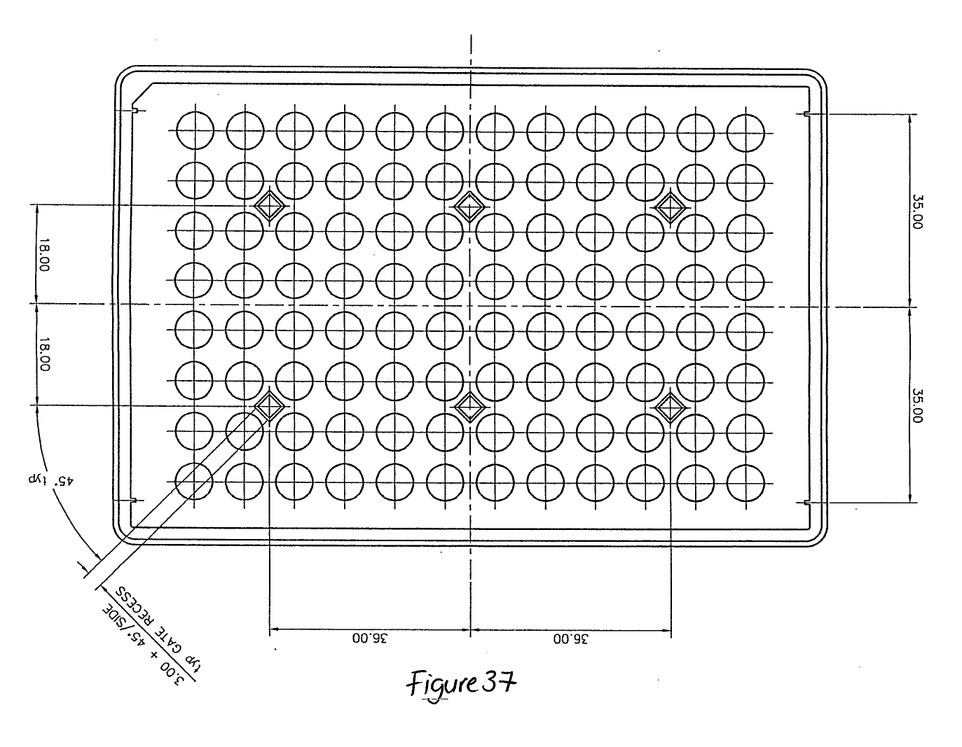

FIG. 4 illustrates a cross-section of a well 20. These wells are designed with thin walls to allow heat transfer to take place between a thermal cycler block and the contents of the well. Typically the walls 21 of the well are between about 0.05 mm and about 0.25 mm thick. It should be appreciated that these values are not intended to represent precise limits. It may be that, for example, technology in the future will allow a well to be constructed with a wall thickness of less than 0.05 mm. But using currently available techniques 0.1 mm represents the typical minimum that can be achieved reliably and have each well complete and intact. This gives a preferred well wall thickness range of 0.1 mm to 0.25 mm.

It will also be appreciated that the well wall is not of uniform thickness everywhere. For example, the bottom of the tube 22 has a slightly thicker wall thickness, and on the top of the well 23 where it meets the deck. Thus when referring to well wall thickness this refers to the wall thickness in the region of the well shown by ‘A’ being the region in which the bulk of any material is stored.

As explained above, such plates tend to distort after being heated in a thermal cycler. However, it has unexpectedly been discovered that by increasing the thickness of the deck and skirt portion that the plates become significantly more rigid and yet surprisingly the plates can still be made successfully using a one shot moulding process. An example of such a plate, including dimensions, is given in FIGS. 6 to 9 inclusive, in which a corresponding numbering system has been used.

These plates are made using a one shot moulding process. The relative dimensions of well wall thickness, deck and skirt thickness and injection points are critical to successful moulding. Problems generally arise in forming reliable products where the product contains regions of very thin wall thickness ie the well walls, and regions which are much thicker, ie the deck and skirt. In these circumstances the mouldings in the very thin region tend to be incomplete.

From FIGS. 7 and 9 it will be seen that a typical thickness for the deck and skirt region in this new design is between 1.5 and 3 mm, although thicker deck and skirt portions are possible. It follows therefore that there is a ratio between the mean value for the thickness of the deck and skirt portion compared to the mean value of the thickness of the well wall. It is necessary to take mean value because, in practice, these thicknesses are not completely uniformed around the whole moulding. This ratio varies from about 6 to about 60. It could be greater than 60 if the well wall thickness is less than 0.05 mm. However, it is unlikely to be less than 6 and still retain the required degree of rigidity.

Typical dimensions for the thickness of the deck and skirt portions are from 1.5 to 3 mm, and preferably about 2 mm.

As explained above, there is a prejudice in the industry against using thick cross-sections in this type of product. The flow characteristics of the molten plastics material through the mould is poor and cycle times are increased dramatically. However, it has been discovered that by using six injection points 130-135 and reducing the thickness of the deck portion in the region of the injection points, eg 136 in FIG. 7, then one shot moulding becomes possible with reasonable cycle times. By reducing the thickness of the mould adjacent to the injection point, the plastics material heats up to a greater degree when entering the mould, thus making the moulding operation more reliable. The thickness of the plastics in this region is substantially the same as it is in the prior art plate.

In any event, the unexpected result of this modification is that there are considerably lower internal stresses and strains in the deck and skirt of these new plates. As a result, they suffer minimal deformation after repeated thermal cycles.

1. A multi-well plate comprising:
(i) a deck and skirt portion said deck and skirt portion having an outer surface and an inner surface;
(ii) a plurality of wells for holding chemical reactants, each well comprising a well wall having an inner surface and an outer surface;
wherein the deck and skirt portion and the plurality of wells are of integral construction and formed from the same plastics material, and wherein the deck and skirt portion has a mean thickness from 1.5 mm±10% to 3 mm±10%.

2. A multi-well plate as claimed in claim 1 wherein the deck and skirt portion has a mean thickness from 1.7 mm±10% to 2.5 mm±10%.

3. A multi-well plate as claimed in claim 1 wherein the deck and skirt portion has a mean thickness of 1.9 mm±10%.

4. A multi-well plate as claimed in any of claims 1 to 3 wherein the ratio of the thickness of the deck and skirt portion, being the mean value of the internal distance between the outer surface and the inner surface, and the mean value of the thickness of the well wall is 6 or greater.

5. A multi-well plate as claimed in any of claims 1 to 3 wherein the ratio of mean deck and skirt portion thickness to mean well wall thickness is 12 or greater.

6. A multi-well plate as claimed in any of claims 1 to 3 wherein the ratio of mean deck and skirt portion thickness to mean well wall thickness is 20 or greater.

7. A multi-well plate as claimed in any of claims 1 to 3 wherein the ratio of mean deck and skirt portion thickness to mean well wall thickness is 30 or greater.

8. A multi-well plate as claimed in any of claims 1 to 3 wherein the ratio of mean deck and skirt portion thickness to mean well wall thickness is 40 or greater.

9. A multi-well plate as claimed in claim 1 wherein the well wall has a mean thickness from about 0.05 to 0.25 mm.

10. (canceled)

11. A multi-well plate comprising:
(i) a deck and skirt portion said deck and skirt portion having an outer surface and an inner surface;
(ii) a plurality of wells for holding chemical reactants, each well comprising a well wall having an inner surface and an outer surface;
wherein the deck and skirt portion and the plurality of wells are of integral construction and formed from the same plastics material, and the ratio of the thickness of the deck and skirt portion, being the mean value of the internal distance between the outer surface and the inner surface, and the mean value of the thickness of the well wall is 6 or greater.

12. A multi-well plate as claimed in claim 11 wherein the ratio of mean deck and skirt portion thickness to mean well wall thickness is 12 or greater.

13. A multi-well plate as claimed in claim 11 wherein the ratio of mean deck and skirt portion thickness to mean well wall thickness is 20 or greater.

14. A multi-well plate as claimed in claim 11 wherein the ratio of mean deck and skirt portion thickness to mean well wall thickness is 30 or greater.

15. A multi-well plate as claimed in claim 11 wherein the ratio of mean deck and skirt portion thickness to mean well wall thickness is 40 or greater.

16. A multi-well plate as claimed in any of claims 11 to 15 wherein the well wall has a mean thickness from about 0.05 to 0.25 mm.

17. A multi-well plate as claimed in claim 11 wherein the deck and skirt portion has a mean thickness from about 1.5 to 3 mm.
